(19) United States
(12) Patent Application Publication
(10) Pub. No.: US 2003/0156525 A1
(43) Pub. Date: Aug. 21, 2003

(54) Method of and system for block-by-block data retrieval for optical storage

(76) Inventors: Bunsen Fan, Peekskill, NY (US); Sadeg M. Faris, Pleasantville, NY (US)

Correspondence Address: Reveo, Inc., 85 Executive Blvd., Elmsford, NY, 10523, US

(21) Appl. No.: 10/295,524

(22) Filed: Nov. 15, 2002

Related U.S. Application Data
(63) Continuation-in-part of application No. 09/141,063, filed on Aug. 27, 1998, now Pat. No. 6,498,775.
Application No. 09/141,063 is a continuation of application No. 08/539,279, filed on Oct. 4, 1995, now Pat. No. 5,838,653.
(60) Provisional application No. 60/332,295, filed on Nov. 16, 2001.

(51) Int. Cl. G11B 7/135

(52) U.S. Cl. 369/110.04; 369/112.17

(57) ABSTRACT

The above-discussed and other problems and deficiencies of the prior art are overcome or alleviated by the several methods and apparatus of the present invention for a block-by-block data retrieval method and system, wherein the data is stored in a multiple layer polarization selective, wavelength selective, or a combination of polarization selective and wavelength selective films.

### RELATED APPLICATIONS

The present invention claims priority to U.S. Provisional Patent Application Serial No. 60/332,295 filed on Nov. 15, 2001 entitled “Method And Apparatus For Block-By-Block Data Retrieval For Optical Storage”, and is a Continuation in Part of U.S. patent application Ser. No. 09/141,063 filed Aug. 27, 1998 entitled “Multi-layer Optical Recording Media and System for Recording and Reproducing Information Data”, which is a Continuation of U.S. Pat. No. 5,838,653 entitled “Multiple Layer Optical Recording Media and Method and System for Recording and Reproducing Information Using the Same”, all of which are incorporated by reference herein.

### BACKGROUND OF INVENTION

1. Field of Invention

The present invention relates to optical data storage and more particularly to storage media employing a novel storing and retrieval process for information storage applications.

2. Background Information

The growing worldwide demand for data storage capacity is evident. For decades, magnetic storage was the dominant method for recording both analog and digital information. Recent advances in magnetic recording, such as superparamagnetism, drastically increase the areal density. However, since the information is stored on a single-layer medium, magnetic recording has encountered a limit in storage capacity. Other popular storage technologies, such as those based on magneto-optics (M-O) and phase-change, exhibit the same fundamental limitation; again, data can only be stored on a single-layer medium. IBM has recently demonstrated magneto-optic storage on two partially transmissive recording surfaces. Nevertheless, a major drawback with this technique is that only a few M-O recording surfaces can be stacked together before the signal-to-noise ratio becomes a problem.

Today, compact disc read-only-memory (CD-ROM) is a valuable and widely used storage technology. The manufacturing cost of a CD-ROM with a storage capacity of approximately 650 MB is as low as $1 per disc. Because of these low production costs, CD-ROM has established its importance in personal computing systems and in a variety of other applications. Attempts have been made to increase the information storage capabilities of conventional CD-ROMs. One technique demonstrated by IBM involved the stacking of conventional CD-ROM discs. By adjusting the focus depth of the readout laser beam, it was possible to read information from a selected disc. Again, the major drawback with this technique was that only about 10 discs could be stacked before the signal-to-noise ratio became a problem.

Recent digital video discs (DVD) are capable of storing 133 minutes of MPEG-2-compressed video. This increased storage capacity is made possible by using two storage layers that are bonded together. While the increase in storage capacity is encouraging, the readout technology is still bit-by-bit along a linear track. The data transfer is 150 MB/s for a single-speed CD-ROMs. Moderate increases in disc rotation speed appear to be the only realistic method for boosting this rate. The limit is set by the power consumption of the spin motor, as it is rotated at a variable speed. Thus, DVD and CD-ROM storage technologies have two severe shortcomings that are proving difficult to overcome:

An inherent bottleneck in the retrieval speed.

Limited potential for storage capacity improvement.

Blue and LTV wavelength laser technology, which should increase the storage capacity yet further, is currently under intense development. However, the bottleneck of data retrieval remains, since readout is still limited to bit-by-bit readout along a spiral line track. The limit is set by the power consumption of the spin motor, as it is rotated at a variable speed. Only minor improvements, such as faster disc rotation, can speed up bit-by-bit readout.

Parallel track reading of optical storage media is also known and has recently undergone commercialization stages. For example, Kenwood has offers (under the trade name True-X™) a parallel track system whereby several optical pick-ups are utilized to read, in parallel, several tracks. However, again, each track is read on a bit by bit level.

Other developments with conventional optical media (i.e., track based) have evolved with the availability of photoelectric detectors. Zen Research, N.V. has undergone efforts to develop reading systems with photoelectric detectors in CD-ROM and DVD-ROM optical storage, as evidenced by U.S. Pat. Nos. 5,426,623, 5,537,385, 5,574,712, 5,598,393 and 5,907,526 issued to Alon et al, all of which are incorporated herein by reference. However, these references teach photoelectric detectors that image plural tracks, and utilize circuitry to read and buffer data in parallel from the tracks, circuitry for electronic tracking of track location, and circuitry for correcting phase errors due to linear velocity variations of the tracks being read. Thus, the limitations of track based optical storage remain, since Alon et al. teach imaging multiple tracks simultaneously, with the space between tracks remaining further limiting storage capacity.

Holographic recording also promises very high-density optical storage. Data is stored in an interference pattern in a special medium and is retrieved in parallel, on a page-by-page basis, rather than serially. Despite concerted research and development effort over the last 30 years, commercialization is still far off. One major technical hurdle is the recording medium. There is no recording medium that is sensitive in the wavelength range of available lasers. Existing media are unstable to temperature variations and tend to erase gradually after each readout operation.

However, Applicants have, in copending application U.S. patent application Ser. No. 09/141,063 filed Aug. 27, 1998 entitled “Multi-layer Optical Recording Media and System for Recording and Reproducing Information Data”, disclosed schemes whereby data is stored and retrieved in utilizing wavelength-division multiplexing (WDM) and polarization discrimination multiplexing (PDM). Such storage and retrieval schemes allow for multi-layered optical reading and writing without the disadvantages associated with other multi-layered optical reading, namely unacceptable signal-to-noise ratio. Other systems using Applicants wavelength-division multiplexing (WDM) and/or polarization discrimination multiplexing (PDM) schemes are disclosed in U.S. Pat. Nos. 6,094,410, 6,005,838, 5,838,653 and 5,353,247, which are hereby incorporated by reference.

Therefore, a need remains in the art to further increase speed of data retrieval, particularly for optical storage utilizing wavelength-division multiplexing (WDM) and/or polarization discrimination multiplexing (PDM) schemes.

### SUMMARY OF THE INVENTION

The above-discussed and other problems and deficiencies of the prior art are overcome or alleviated by the several methods and apparatus of the present invention for a block-by-block data retrieval method and system, wherein the data is stored in a multiple layer polarization selective, wavelength selective, or a combination of polarization selective and wavelength selective films.

The above and other features and advantages of this invention will be more readily apparent from a reading of the following detailed description of various aspects of the invention taken in conjunction with the accompanying drawings.

### BRIEF DESCRIPTION OF THE DRAWINGS

FIGS. 1A-1C illustrate schematic layouts for the disclosed retrieval system for optical memory;

FIGS. 2A1-2A3, 2B1-2B3 and 2C illustrate schematically stacks of chiral films for data storage;

FIG. 3A illustrates data organization on a film when retrieved by bit-by-bit;

FIG. 3B illustrates data organization on a film when retrieved by block-by-block;

FIG. 4 illustrates a preferred embodiment of organizing data in a hexagonal shape that closely packed;

FIG. 5 illustrates another preferred embodiment of organizing data in a square shape that closely packed;

FIGS. 6A and 6B illustrates a partial list of NRZ coding for a 3×3 block; and

FIG. 7 is a flowchart representation of one embodiment of the data recovery of the present invention.

### DETAILED DESCRIPTION

The present invention will now be described in more detail, with reference to the accompanying figures, wherein like elements are identified with like reference numbers.

The present invention is related to a high-throughput data retrieval method for optical memory technology using polarization selective and/or wavelength selective layers. Briefly, the memory technology uses 3-D stacking of multiple paired films that have unique optical properties. These storage layers have regions with a wavelength- and polarization-selective reflectance and non-reflectance to represent the two binary values, as taught in copending application U.S. patent application Ser. No. 09/141,063. The data retrieval method uses image capture and pattern recognition techniques instead of the usual bit-by-bit read out technique to retrieve a large block of data in a single step, thereby obviating the need for optical storage media having essentially all of its data arranged in linear tracks. The film stack can therefore provide very high areal data storage densities, since track separation is not required, and regions of each film layer with a wavelength- and polarization-selective reflectance and non-reflectance may be planar adjacent (i.e., adjacent in two dimensions), as compared to conventional bit by bit systems which may only be adjacent in one direction, i.e., linearly. Thus, data may be read utilizing massive parallelism, or on a “block-by-block” basis.

This invention is potentially advantageous in that the throughput in data retrieval and storage capacity may be increased greatly. This invention is further advantageous in that it can use an incoherent light source instead of a focused laser beam. This invention has other advantageous attributes, which will become clear.

and is readily achievable thanks to recent progress in digital signal processing and CMOS imager chip technologies.

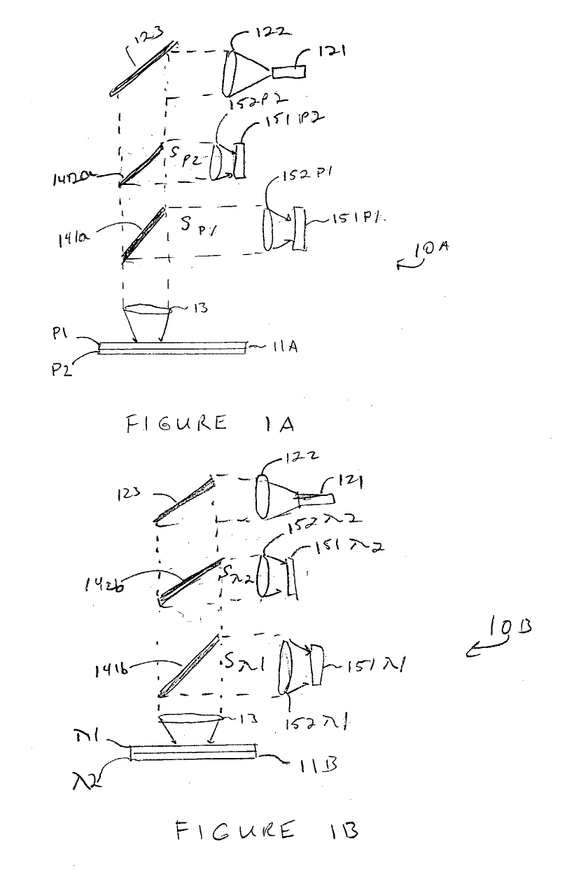

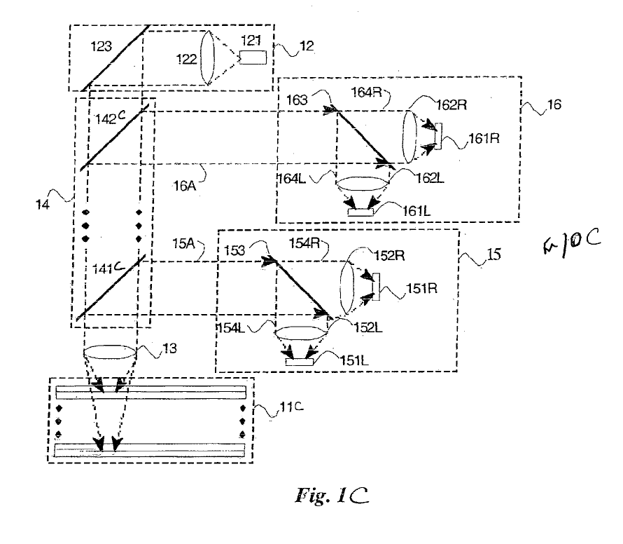

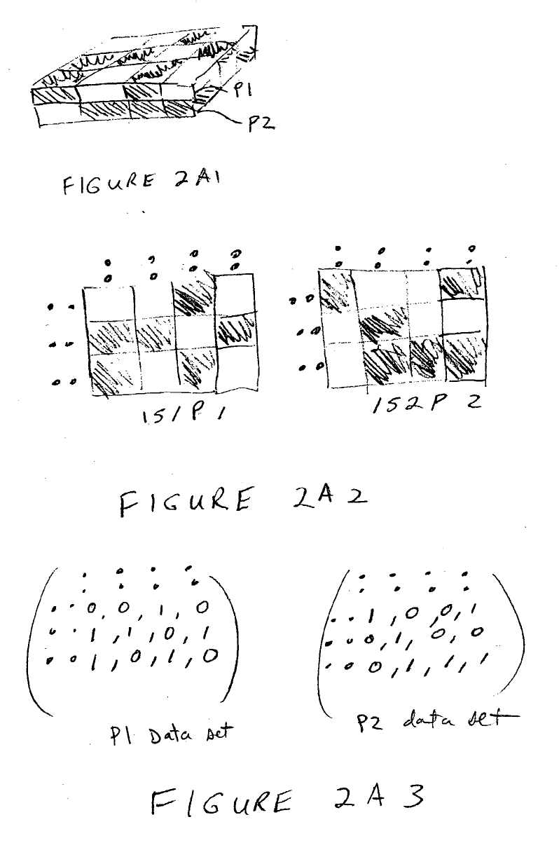

FIG. 1A illustrates a system 10A using the disclosed retrieval method. A media source 11 includes a pair of layers P1 and P2, representing a first and second polarization state, which may be LH & RH circular polarizations, two orthogonal linear polarization states, or two orthogonal elliptical states. The media source 11 stores the binary data.

A light source 121, an optical collimator 122 and a beam-steering mirror 123 are provided as a light source subsystem. As the readout uses imaging technique, the light source can be incoherent such as the radiation emitted by a tungsten halogen light bulb, for example. Unpolarized light is preferred. The optical collimator 122 is a set of optical lenses. Its main function is to shape the beam illuminating on the storage films. The beam-steering mirror 123 is a mirror. Its function is to re-direct the beam propagation path for convenient arrangement in optics. A spectral filter or a set of filters may be used to block radiation outside the signal spectral. For simplicity, these are not shown. The function of beam-steering mirror and the spectral filters can be combined into one optical element, using a reflector with a multiplayer dielectric coating that reflects only the radiation of useful spectral range.

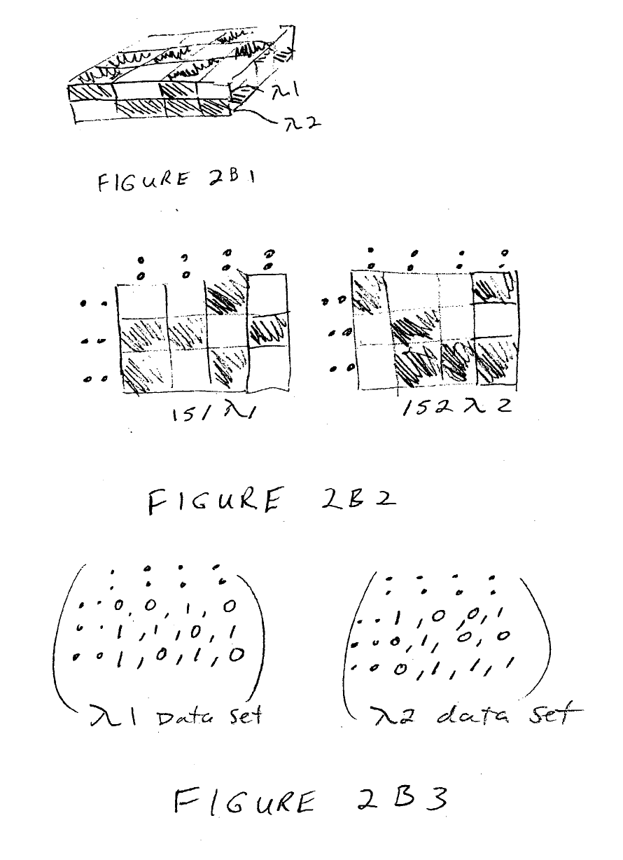

An objective optics 13 is provided to illuminates the film stack and collect the reflected signal light from the film stack. This signal is polarization separated into two images, according to the polarization, P1 and P2, which are orthogonal to each other. The polarization selective system includes a set of optical filters 141A and 142A, which reflect, respectively, the signal beams S_{P1} and S_{P2}. Signal beams S_{P1} and S_{P2} are collected and focused (optionally) by lenses 152P1 and 152P1, respectively, and imaged with imagers 151P1 and 151P2, respectively. Thus, the system 10A utilizes polarization discrimination multiplexing (PDM) of the reflected light to increase storage capacity, and retrieval speed is increased by imaging and processing several regions at one time, as shown in FIG. 2A1-2A3.

FIG. 1B illustrates a system 10B using the disclosed retrieval method. A media source 11 includes a pair of layers λ1 and λ2, representing a first and second wavelength ranges. The media source 11 stores the binary data. The light source subsystem is similar to that of system 10A.

An objective optics 13 is provided to illuminates the film stack and collect the reflected signal light from the film stack. This signal is wavelength separated into two images, according to the wavelengths λ1 and λ2, which are preferably non-overlapping to eliminate cross-talk. The wavelength-division system includes a set of optical notch 141B and 142B, which reflect, the signal beams S_{λ1} and S_{λ2} of spectral bands centered at λ1 and λ2. Typically, the notch filters are multi-layer dielectric coatings that are designed to reflect a spectral band while transmitting the remainder. Signal beams S_{λ1} and S_{λ2} are collected and focused (optionally) by lenses 152λ1 and 152λ2, respectively, and imaged with imagers 151 λ1 and 151 λ2, respectively. Thus, the system 10B utilizes wavelength-division multiplexing (WDM) of the reflected light to increase storage capacity, and retrieval speed is increased by imaging and processing several regions at one time, as shown in FIG. 2B1-2B3.

FIG. 1C illustrates another system 10C using the disclosed retrieval method. It includes of the following sub-systems: a stack of films 11 that stores the binary data, a light illumination subsystem 12 that illuminates the stack 11, an objective optics 13 that illuminates the film stack and collects the reflected signal light from the film stack 11, wavelength demultiplexer 14 that separates the reflected signals into a plurality of read channels 15A and 16A, according to the signal wavelength, and image processors 15 and 16 for the wavelength demultiplexed signals. The de-multiplexed signals 15A and 16A are separated into two images, according to the polarization, P1 and P2, which are orthogonal to each other. The disclosed method utilizes wavelength-division multiplexing (WDM) and polarization discrimination multiplexing (PDM) of the recording channels to increase both storage capacity and retrieval speed.

The illumination subsystem 12 is similar to that described with respect to FIG. 1A, including a light source 121, an optical collimator 122 and a beam-steering mirror 123. The wavelength de-multiplexer 14 includes a set of optical notch filters 141C and 142C, which reflect, respectively, the signal beams 15A and 16A of spectral bands centered at λ1 and λ2. The two spectral bands do not overlap in order to eliminate cross-talk. Typically, the notch filters are multi-layer dielectric coatings that are designed to reflect a spectral band while transmitting the remainder.

As described in the herein example, the films are chiral such that the opposing polarization states are right handed and left handed. The signal beam 15A is reflected from the pair of right- and left-handed chiral films 22R and 22L as illustrated in FIG. 2C. The signal is divided into two beams 154R and 154L, which are of right-handed and left-handed circular polarization, respectively, using a circular polarizer 153. The separated beams are then imaged separately with imagers 151R and 151L, respectively, for the signal beams 154R and 154L. The objective lens 13 and lens 152R form the imaging optics for the right-hand polarized beam. The objective lens 13 and lens 152L form the imaging optics for the left-hand polarized beam. Similarly, the signal beam 16A is reflected from the pair of right- and left-handed chiral films 23R and 23L (FIG. 2C). It is further divided into two beams 164R and 164L, which are of right-handed and left-handed circular polarization, respectively, using a circular polarizer 163. The separated beams are then imaged separately with imagers 16IR and 162L, respectively, for the signal beams 164R and 164L. The objective lens 13 and lens 162R form the imaging optics for the right-hand polarized beam. The objective lens 13 and lens 162L form the imaging optics for the left-hand polarized beam.

The potential advantage of utilizing PDM is that data stored on a pair of chiral films, which are in close proximity, can be read out simultaneously. It will become clear that with pattern recognition techniques, precise overlay of the paired chiral films are not required. The retrieval throughput can be doubled. Actual improvements may be greater as the time required to mechanically move and focus the readout optics between reading two “blocks” is completely eliminated.

For block reading, the microscope image can be detected by a video camera and then analyzed. Charge-coupled-device (CCD) imaging chips can be used. CMOS imagers are preferred; as they have the inherent advantages of single-voltage operation, low power consumption and the ability to integrate with other electronics, including DSP cores, CPUs and memory. The development of CMOS imager technology is rapid, as digital cameras with various resolutions appear on the consumer market.

The optical storage media of the present invention may generally comprise chiral films, which exhibit wavelength- and polarization-selective reflectance. As illustrated in FIG. 2C, the films are arranged in pairs, which reflects right-handed and left-handed circularly polarized light at a wavelength. For example, the top pair includes films 22R and 22L that reflects RHCP and LHCP at wavelength λ1. The bottom pair includes films 23R and 23L that reflects RHCP and LHCP at wavelength λ2. Each information storage cell which stores a pre-specified binary value “1” (crosshatch-marked region) reflects light with wavelength λ1 or λ2. Each information storage cell that stores pre-specified binary value “0” (clear-marked region) does not reflect light with characteristic wavelength λ1 or λ2. When light 21 incident on the chiral film stack, the cells (indicated by location “b”) reflect a light 22, which has the spectral components of LHCP light at λ1 and λ2 from films 22L and 23L. When light 21 incident on the chiral film stack, the cells (indicated by location “c”) reflect a light 23, which has the spectral components of RHCP light at includes of LHCP light at λ1 from films 22R and LHCP light at λ2 from film 23L.

Suitable chiral films for the data storage have been discussed in aforementioned U.S. Pat. Nos. 6,094,410, 6,005,838, 5,838,653 and 5,353,247.

The disclosed retrieval method uses an essentially a modified optical microscope operating in the reflecting mode. The main modification is that a circularly polarizing beam splitter is used to separate the incoming signal into two images of orthogonal polarization states; these images correspond to the information stored on the RH and LH chiral films. The respective processor then decodes each spatially separated image. The advantage of using paired chiral films now becomes apparent: the reading speed is doubled as compared to the reading speed for one-layer by-one-layer. Another advantage of using such setup is also clear now. The light source can be incoherent and thereby making it practical to implement WDM. On the other hand, the present CD/DVD technology, which uses retrieves data bit by bit, requires a tightly focused laser beam. To implement WDM with present CD/DVD technology, a set of lasers with different output wavelengths is required and these lasers are currently unavailable.

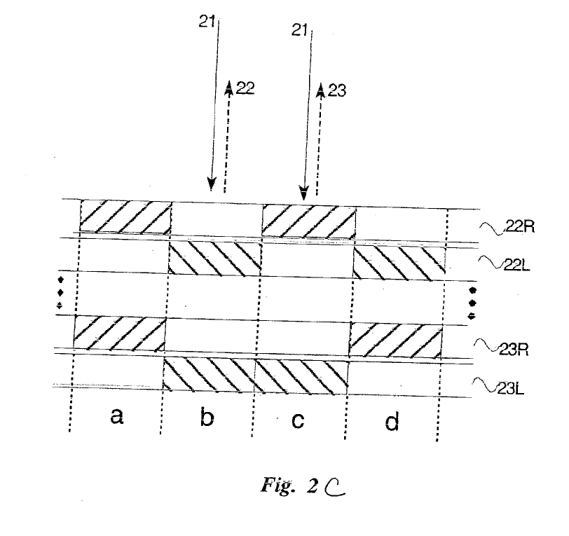

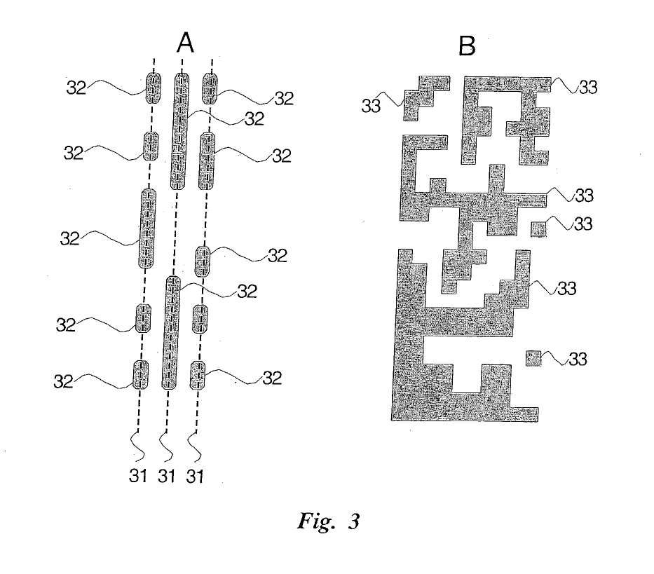

FIG. 3A illustrates data organized on a CD/DVD disc which are retrieved by bit-by-bit. The data marks 32 are positioned a spiral track; a few segments of the track are indicated by 31. For the disclosed retrieval method, the data marks, which are squares or rectangles, are positioned along each other, in a group or block, as shown in FIG. 3B. Note the potential advantage of the present invention. The spacing between the track segments is not required and the spacing can be used for data, thereby increasing the areal storage density by a factor of about 2.

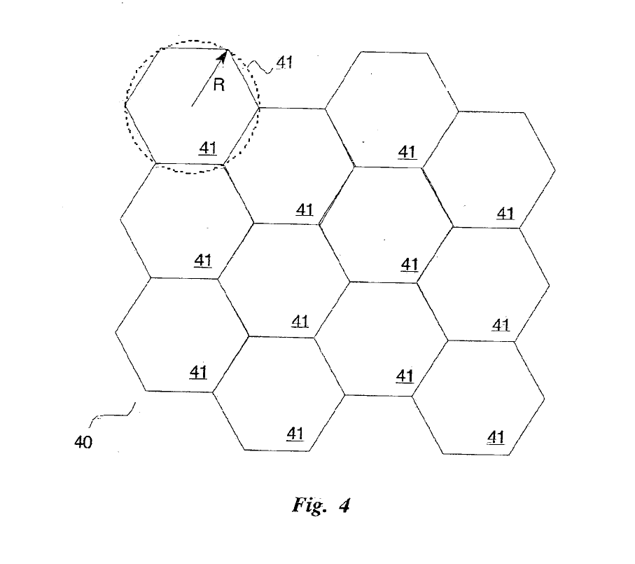

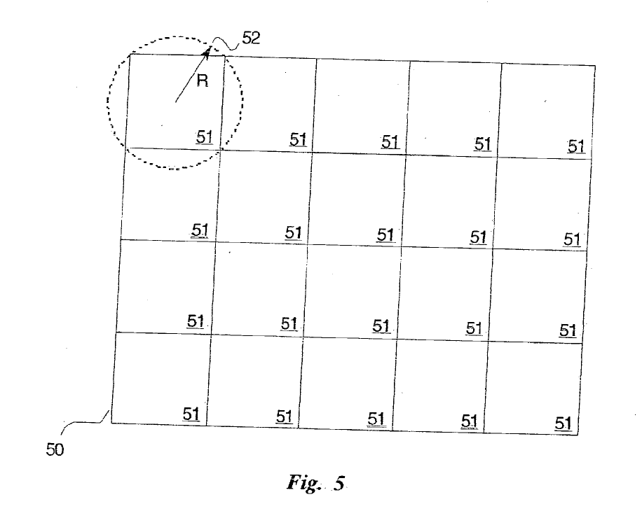

Typical imaging optics has a circular field of view (FOV). Two block schemes are preferred. FIG. 4 illustrates data 40 are grouped in hexagonal blocks 41 with the FOV indicated by dashed circle 42. FIG. 5 shows data 50 are grouped in square blocks 51, with the FOV indicated by dashed circle 52. For a FOV of radius R, the maximum area for an enclosed hexagon is A_{hexagon}=(3 √3/2)R² and the maximum area for an enclosed square is A_{square}=2 R². The ratio of the coverage, A_{hexagon}/A_{square} is 1.3. Thus, under the same conditions, data retrieval for hexagonal block is 30% faster than that for the square block. Again, the improvements in the readout speed will be higher, as a consequence of the reduction in total time needed to position the optics between readouts. The data blocks of a square (or rectangular) shape are practical in near term, as most image sensors are of rectangular in shape.

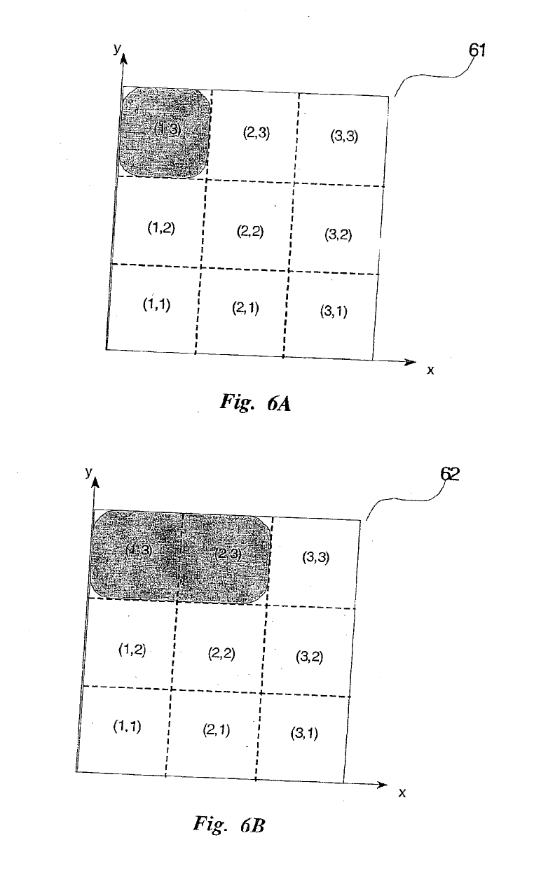

FIGS. 6A and B illustrate examples of data organization taking advantage of block retrieval method. It illustrates a partial list of non-return-zero (NRZ) coding for a block of 3 bit by 3 bit in a rectangular shape. The cells are arranged in Cartesian coordinates (x, y), where x and y are equal to 1, 2 or 3. FIG. 6A shows the cell (1, 3) of the block 61 is recorded as logical “1” with other cells as logical “O”. FIG. 6B shows the cells (1, 3) and (2, 3) of the block 62 are recorded as logical “1” with other cells as logical “0”. There are 2⁹=512 possible combinations. Other coding schemes, such pulse length modulation, pulse position modulation are possible. For coding on a linear track (not shown), a clock signal, which is used to control the disc rotation, is embedded in the coding (by restriction of the maximum number of neighboring “1”s and “0”s). In the 2-D coding shown here, there is no requirement for such clock signal, as the entire image of the data block is captured and then recognized.

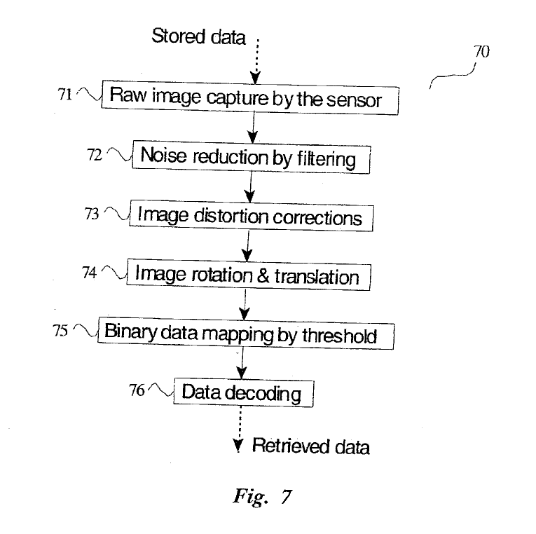

FIG. 7 illustrates a flowchart of a method 70 for recovering the data from image is illustrated. The raw image captured by the imager 71 is first processed to rid of excess noise, by band pass filtering 72. For example, the brightness of image (assume the ‘1’ bits are more or less are uniformly distributed) varies over the entire field of view, due to non-uniform illumination. This is a noise of low spatial frequency. Another example is that there are impulse noises that randomly occur to alter the values of some pixels. It is classified as an additive noise and commonly called “salt and pepper” noise, as in binary image, some white pixels become black and some black pixels become white. This noise has a high spatial frequency. The filtering can be easily implemented by fast Fourier transform the image, filtering the transform and then fast inverse Fourier transform. The filtering can also be conveniently done in real domain by convolution. The resulting image is one without random spikes and localized variations.

The filtered image is then corrected for various physical distortions 73, for example, aberrations introduced by imaging optics. For example, a perfectly straight line on the object may become somewhat curved in the image which leads to pincushion and barrel. Such geometric distortions in raw images are sometimes unavoidable, as a result of tradeoffs in the design and fabrication process of the imaging optics. Since such image distortion is fixed for the optics, it can be easily corrected using calibration. By imaging a reference object, for example, of checkerboard or wire grid pattern, the distortion can be extracted from the image, by finding the one-to-one coordinate correspondence between the pixels of distorted and ‘perfect’ images.

The corrected image is the digitally rotated and translated 74. The advantage is that the digital process eliminates most time-consuming mechanical alignment between the data films and image sensor. As a result, the speed of data retrieval is further improved. The image rotation and translation are re-mapping. The digital rotation and translation are aided by a string of reference data marks placed at the boundaries of the read-out block. For examples, the locations can be the four comers of rectangular data blocks. Such groups of data mark, which can be of limited variation, are fixed on the read-out block can also serve as marks for focusing.

The binary data are then recovered from the image by threshold 75. One preferred approach is threshold detection. The logical value of the bit is based on the relative magnitudes between the bit value and a preset threshold. The threshold can be set from histogram of the image. The logical value of the bit is ‘1’ if its value is above the threshold and ‘O’ if its value is below the threshold. It is clear that fixed threshold detection may become unreliable in noisy conditions. For example, the chiral film does not have uniform reflectance over the retrieved block, due to inevitable causes such as media noise associated with multiple texture domains in the CLC chiral films. To reduce rates of decision errors, it is best vary the threshold setting over the block being retrieved. Such variable threshold can be determined from averaged reflectance over a small region surrounding the bit to be decided. The averaged region is small enough to account the slow changes in the signal, but sufficiently large to include nearly equal bits of ‘I1s and ‘0’s.

The other preferred approach is transition detection. The logical value of the bit is determined based on the transition between high and low bit values of neighboring bits. If the transition is down (high to low) the two bits are ‘10’ and if the transition is up (low to high) the two bits are ‘01’. To avoid excess decision errors, the process usually contains some hysteresis, which is set by the magnitude of the up- and down-transitions. To reduce rates of decision errors, it is best vary the hysteresis setting over the block being retrieved. Such variable hysteresis can be determined by averaging transition magnitudes over a small region surrounding the bit to be decided. The averaged region is small enough to account the slow changes in the signal, but sufficiently large to include nearly equal up- and down-transitions.

Another important advantage of the present invention is that to speed up image processing, the image may be rotated by software and/or translated digitally, thereby eliminating the requirement for precise orientation between the data films and the image sensor. The image rotation and translation are not distortion correction, but rather re-mapping performed to simplify the extraction of data from the raw image. Digital rotation and translation will speed up readout operation, as mechanical alignment process are relatively time consuming in data read operations.

Optionally, the digital rotation and translation may be aided with one or more data reference marks placed at the boundaries of a read-out block. For example, locations may be at the four corners of a rectangular block, as shown in FIG. 3B.

For rotation, the filtered image S′(x, y) is first zoomed, which is obtained by expansion in pixel coordinate scale:

S′(xᵢ′,yᵢ′)←S(xᵢ, yᵢ) (2.5)

with xᵢ′=Kxᵢyᵢ′=Kyᵢ and K is an integer. The zooming is necessary for rotation, which is defined by coordinate transformation:

xᵢ′=xᵢ cos θ and yᵢ′=yᵢ sin θ (2.6)

where θ is the rotation angle. The rotated coordinates are not necessary integers, thus requires truncation or interpolation. Truncation is simply rounding off the fractions. Interpolation is essentially examining the value of nearest neighbors and averaging them—the so-called bilinear interpolation. Zooming reduced the truncation or interpolation errors. After rotation, the pixel coordinates are de-zoomed or reduced back to the original coordinate scale by xᵢ″=K⁻¹xᵢ′yᵢ″=K⁻¹yᵢ′.

S″(xᵢ″,yᵢ″)←S′(xᵢ′, yᵢ′) (2.7)

Again, truncation or interpolation is required to form integer coordinates. The image translation is rather straightforward by coordination translation:

xᵢ=xᵢ+X₀ and yᵢ=yᵢ+Y₀ (2.8)

where (X₀, Y₀) is the amount of translation is needed.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A method of data retrieval comprising:
illuminating a multiple film stack of polarization dependant films, each film having plural regions of reflectance and/or non-reflectance corresponding to data marks, the reflected light including a plurality of such regions;
splitting reflected light into a pair light signals of polarizations states P1 and P2;
separately imaging the pair light signals of polarizations states P1 and P2 to form a P1 image and a P2 image; and
processing the P1 image and the P2 image to derive data.

2. A method of data retrieval comprising:
illuminating a multiple film stack of wavelength dependant films, each film having plural regions of reflectance and/or non-reflectance corresponding to data marks, the reflected light including a plurality of such regions;
splitting reflected light into a pair light signals of wavelength bands λ1 and λ2;
separately imaging the pair light signals of wavelength bands λ1 and λ2 to form a λ1 image and a λ2 image; and
processing the λ1 image and the λ2 image to derive data.

3. A method of block-by-block data retrieval for optical storage comprising:
capturing raw image data with a sensor;
filtering said image for noise reduction;
correcting image distortions;
rotating and translating said image;
binary data mapping; and
decoding said data, wherein said data is retrieved.

4. An apparatus for block-by-block data retrieval comprising:
a stack of polarization selective films that store data;
a light illumination subsystem that illuminates the stack;
an objective optics that illuminates the film stack and collects the reflected signal light from the film stack;
a polarization beam splitter that separates the reflected signals into a pair of orthogonal polarized signals; and
a plurality of image processors for each of the pair of orthogonal polarized signals, wherein said pair of orthogonal polarized signals are separated into two images.

5. An apparatus for block-by-block data retrieval comprising:
a stack of wavelength dependant films that store data;
a light illumination subsystem that illuminates the stack;
an objective optics that illuminates the film stack and collects the reflected signal light from the film stack;
a wavelength de-multiplexer that separates the reflected signals into a plurality of signals having different wavelength bands; and
a plurality of image processors for the wavelength-demultiplexed signals, wherein said de-multiplexed signals are separated into two images.

6. An apparatus for block-by-block data retrieval comprising:
a stack of chiral films that store data;
a light illumination subsystem that illuminates the chiral stack;
an objective optics that illuminates the film stack and collects the reflected signal light from the chiral film stack;
a wavelength de-multiplexer that separates the reflected signals into a plurality of signals, according to the signal wavelength; and
a plurality of image processors for the wavelength-demultiplexed signals,
wherein said plurality of de-multiplexed signals are each separated into two images, according to the polarization, P1 and P2, which are orthogonal to each other.
